(19) United States
(12) Patent Application Publication
(10) Pub. No.: US 2013/0211729 A1
(43) Pub. Date: Aug. 15, 2013

(54) DATA ANALYSIS OF DNA SEQUENCES

(71) Applicant: Dow Agrosciences LLC, (US)

(72) Inventors: Lakshmi Sastry-Dent, Avon, IN (US); Shreedharan Sriram, Indianapolis, IN (US); Navin Elango, Indianapolis, IN (US); Zehui Cao, Westfield, IN (US); Karthik Narayan Muthuraman, Indianapolis, IN (US)

(73) Assignee: DOW AGROSCIENCES LLC, Indianapolis, IN (US)

(21) Appl. No.: 13/761,711

(22) Filed: Feb. 7, 2013

Related U.S. Application Data
(60) Provisional application No. 61/596,540, filed on Feb. 8, 2012.
(60) Provisional application No. 61/601,090, filed on Feb. 21, 2012.

(51) Int. Cl. G06F 19/28

(52) U.S. Cl. CPC G06F 19/28
USPC 702/19

(57) ABSTRACT

Systems and methods for data analysis are provided. In one embodiment, a method for analysis is provided, including electronically receiving sequence data; electronically receiving one or more reference data sequences related to at least an expression vector; associating the sequence data with at least one of the reference data sequences to identify a transgene flanking sequence; searching a genome for one or more insertion sites of the transgene flanking sequence; and annotating the genome and the one or more insertion sites within the genome when one or more insertion sites are found in said searching step.

### CROSS REFERENCE TO RELATED APPLICATIONS

This application claims the benefit of U.S. Provisional Patent Application No. 61/596,540 filed on Feb. 8, 2012 and U.S. Provisional Patent Application No. 61/601,090, filed on Feb. 21, 2012, the disclosures of which are expressly incorporated herein by reference in their entirety.

### FIELD OF THE DISCLOSURE

The present disclosure relates in part to the computerized analysis of sequencing data. More particularly, the present disclosure relates in part to the computerized process of identifying and analyzing genome modifications such as transgene insertion sites.

### BACKGROUND OF THE DISCLOSURE

The identification and characterization of transgene flanking sequences may be needed for the commercialization and registration of products that contain transgene sequences. The identification and characterization of transgene flanking sequences may also be important for other types of activities, like characterization of events generated by EXZACT™ Precision Technology brand genome modification technology. For example, EXZACT™ Precision Technology brand genome modification technology is a cutting-edge, versatile and robust toolkit for genome modification. It is based on the design and use of zinc finger nucleases (“ZFNs”) which are proteins that can be designed to bind to sequence specific DNA sequences. EXZACT™ brand technologies can be used to generate ZFN-promoted double strand breaks within the genome of an organism, thereby resulting in the targeted insertion of transgenes at a specific loci of interest in a DNA sequence.

The transgene flanking sequence consists of a chromosomal flanking region of the genomic integration site and the integrated transgene. The transgene flanking sequences may contain deletions, inversions, or insertions which result from the integration of the transgene into a specific location of the chromosome. Regions of nucleic acid similarity may exist between the transgene DNA, the cloning vector used in sequencing, primers and/or adapters used to isolate the transgene flanking region sequence, the chromosomal sequence in which the transgene has integrated, and other unrelated DNA fragments which have been inserted into the genome via unexpected rearrangements.

Various methods can be used to isolate a transgene flanking region sequence. This transgene flanking region sequence can then be sequenced using traditional dideoxy sequencing methods, chain termination sequencing methods, or via Next Generation Sequencing methods.

As described by Brautigma et al., 2010, DNA sequence analysis can be used to determine the nucleotide sequence of the isolated and amplified fragment. The amplified fragments can be isolated and sub-cloned into a vector and sequenced using chain-terminator method (also referred to as Sanger sequencing) or Dye-terminator sequencing. In addition, the amplicon can be sequenced with Next Generation Sequencing. NGS technologies do not require the sub-cloning step, and multiple sequencing reads can be completed in a single reaction. Three NGS platforms are commercially available, the Genome Sequencer FLX from 454 Life Sciences/Roche, the Illumina Genome Analyser from Solexa and Applied Biosystems' SOLiD (acronym for: ‘Sequencing by Oligo Ligation and Detection’). In addition, there are two single molecule sequencing methods that are currently being developed. These include the true Single Molecule Sequencing (tSMS) from Helicos Bioscience and the Single Molecule Real Time sequencing (SMRT) from Pacific Biosciences.

The Genome Sequencer FLX which is marketed by 454 Life Sciences/Roche is a long read NGS, which uses emulsion PCR and pyrosequencing to generate sequencing reads. DNA fragments of 300-800 bp or libraries containing fragments of 3-20 kbp can be used. The reactions can produce over a million reads of about 250 to 400 bases per run for a total yield of 250 to 400 megabases. This technology produces the longest reads but the total sequence output per run is low compared to other NGS technologies.

The Illumina Genome Analyser which is marketed by Solexa is a short read NGS which uses sequencing by synthesis approach with fluorescent dye-labeled reversible terminator nucleotides and is based on solid-phase bridge PCR. Construction of paired end sequencing libraries containing DNA fragments of up to 10 kb can be used. The reactions produce over 100 million short reads that are 35-76 bases in length. This data can produce from 3-6 gigabases per run.

The Sequencing by Oligo Ligation and Detection (SOLiD) system marketed by Applied Biosystems is a short read technology. This NGS technology uses fragmented double stranded DNA that are up to 10 kbp in length. The system uses sequencing by ligation of dye-labeled oligonucleotide primers and emulsion PCR to generate one billion short reads that result in a total sequence output of up to 30 gigabases per run.

tSMS of Helicos Bioscience and SMRT of Pacific Biosciences apply a different approach which uses single DNA molecules for the sequence reactions. The tSMS Helicos system produces up to 800 million short reads that result in 21 gigabases per run. These reactions are completed using fluorescent dye-labeled virtual terminator nucleotides that is described as a ‘sequencing by synthesis’ approach.

The SMRT Next Generation Sequencing system marketed by Pacific Biosciences uses a real time sequencing by synthesis. This technology can produce reads of up to 1000 bp in length as a result of not being limited by reversible terminators. Raw read throughput that is equivalent to one-fold coverage of a diploid human genome can be produced per day using this technology.

The analysis of the DNA sequencing data, where the transgene DNA sequence is distinguished from the chromosomal DNA flanking sequence and any chromosomal rearrangements, is time consuming if done manually, especially for large numbers of sequence datasets. Manually identifying and annotating the transgene DNA sequences and distinguishing these sequences from rearrangements, deletions, and additions which result from the integration of the transgene within the genome is a laborious and difficult task, the results of which are prone to human error.

### SUMMARY

A high-throughput method is needed to confirm that a transgene is integrated into the genome, and for identifying the specific chromosomal location of a transgene, if inserted through random integration or targeted to a site specific locus via homologous recombination. A flexible, high-throughput transgene flanking sequence analysis system is provided to analyze sequence data and define transgene insertion sites within the genome of an organism. The method, in an embodiment, includes steps to identify and annotate the transgene and the transgene flanking sequence, including the chromosomal flanking sequence, within a contiguous DNA fragment of, for example and without limitation, a complete genome. The analysis system contains, in an embodiment, a graphical user interface, an analysis pipeline, and a summary display for input sequences.

In an exemplary embodiment, the present disclosure includes a method for analysis. The method comprises: electronically receiving sequence data, electronically receiving one or more reference data sequences related to at least an expression vector, associating the sequence data with at least one of the reference data sequences to identify a transgene flanking sequence, searching a genome for one or more insertion sites of the transgene flanking sequence, and annotating the genome and the one or more insertion sites within the genome when one or more insertion sites are found.

In a further embodiment of any of the above embodiments, the reference data is further related to at least one primer. In a further embodiment of any of the above embodiments, the reference data is further related to at least one adapter. In a further embodiment of any of the above embodiments, the reference data is related to at least a primer and an adapter. In a further embodiment of any of the above embodiments, the reference data is further related to at least one cloning vector. In a further embodiment of any of the above embodiments, the reference data is further related to a right cloning vector and a left cloning vector.

In a further embodiment of any of the above embodiments, the reference data is further related to at least one of a left cloning vector, a primer, an adapter, a right cloning vector, and a transgene expression vector sequence.

In another further embodiment of any of the above embodiments, the reference data is further related to a cloning vector, a primer, and an adapter. In another further embodiment of any of the above embodiments, the reference data is further related to a left cloning vector, a right cloning vector, a primer, and an adapter.

In a further embodiment of any of the above embodiments, the method further includes searching the sequence data for a first reference data sequence; and searching the sequence data for a second reference data sequence when said first reference data sequence is located. In a further embodiment of any of the above embodiments, the first reference data sequence is selected from the group consisting of: an expression vector, an adapter, a primer, and a cloning vector sequence. In a further embodiment of any of the above embodiments, the second reference data sequence is selected from the group consisting of: an expression vector, an adapter, a primer, and a cloning vector, sequence, the second reference data sequence being selected independently of the first reference data sequence. In a further embodiment of any of the above embodiments, the first reference data sequence is an expression vector and the second reference data sequence is an adapter. In a further embodiment of any of the above embodiments the first and second reference data sequences are independently selected from the group consisting of: a primer and an adapter.

In a further embodiment of any of the above embodiments, associating the sequence data with the reference data sequence includes finding the exact sequence of the reference data sequence. In another further embodiment of any of the above embodiments, associating the sequence data with the reference data sequence includes finding the sequence within a margin of error of five percent of the base pairs in the reference data sequence.

In an additional exemplary embodiment, the present disclosure includes a system for analysis. In the embodiment, the system includes a module for receiving sequence data, a module for receiving one or more reference sequences related to at least an expression vector, and a calculation module operable to associate the sequence data with at least one of the reference data sequences to identify a transgene flanking sequence, search a genome for one or more insertion sites of the transgene flanking sequence, and annotate the genome and the one or more insertion sites within the genome when the one or more insertion sites are found.

In a further embodiment of any of the above embodiments, the reference sequences are further related to at least one primer. In a further embodiment of any of the above embodiments, the reference sequences are further related to at least one adapter. In a further embodiment of any of the above embodiments, the reference sequences are related to at least a primer and an adapter. In a further embodiment of any of the above embodiments, the reference sequences are further related to at least one expression vector sequence. In a further embodiment of any of the above embodiments, the reference sequences are further related to at least one cloning vector. In a further embodiment of any of the above embodiments, the reference sequences are further related to a right cloning vector and a left cloning vector.

In a further embodiment of any of the above embodiments, the reference sequences are further related to at least one of a left cloning vector, a primer, an adapter, a right cloning vector, and an expression vector sequence.

In another further embodiment of any of the above embodiments, the reference sequences are further related to at least a cloning vector, a primer, and an adapter. In another further embodiment of any of the above embodiments, the reference sequences are further related to at least a right cloning vector, a left cloning vector, a primer, and an adapter.

In a further embodiment of any of the above embodiments, the computation module is further operable to search the sequence data for a first reference data sequence; and search the sequence data for a second reference data sequence when said first reference data sequence is located. In a further embodiment of any of the above embodiments, the first reference data sequence is selected from the group consisting of: an expression vector, an adapter, a primer, and a cloning vector sequence. In a further embodiment of any of the above embodiments, the second reference data sequence is selected from the group consisting of: an expression vector, an adapter, a primer, and a cloning vector sequence, the second reference data sequence being selected independently of the first reference data sequence. In a further embodiment of any of the above embodiments, the first reference data sequence is an expression vector and the second reference data sequence is an adapter. In a further embodiment of any of the above embodiments the first and second reference data sequences are independently selected from the group consisting of: a primer and an adapter.

In a further embodiment of any of the above embodiments, associating the sequence data with the reference data sequence includes finding the exact sequence of the reference data sequence. In another further embodiment of any of the above embodiments, associating the sequence data with the reference data sequence includes finding the sequence within a margin of error of five percent of the base pairs in the reference data sequence.

Additional features and advantages of the present disclosure will become apparent to those skilled in the art upon consideration of the following detailed description of the illustrative embodiments exemplifying the best mode of carrying out the invention.

### BRIEF DESCRIPTION OF THE DRAWINGS

The detailed description of the drawings particularly refers to the accompanying figures in which:

FIG. 1A is an exemplary diagram showing a typical sequence which is produced, comprising a left cloning vector, a primer, a expression vector, a transgene flanking region sequence, an adapter, and a right cloning vector according to an embodiment of the present disclosure.

FIG. 1B is an exemplary diagram showing a transgene insertion within the genome comprising an expression vector, a primer sequence and a transgene flanking region sequence inserted between sections of genome sequence according to an embodiment of the present disclosure.

FIG. 2A shows the flow of data and samples from sample input to the analysis system according to an embodiment of the present disclosure.

FIG. 2B shows a flow chart showing a method of data analysis according to an embodiment of the present disclosure.

FIG. 3 is a system diagram of a data analyzer according to an embodiment of the present disclosure.

FIG. 4 is a flow chart showing a method of data analysis according to an embodiment of the present disclosure.

FIG. 5A is a flow chart showing a flanking sequence identification processing sequence or method according to the flow chart of FIG. 4.

FIG. 5B is a flow chart showing a method of identifying and marking a transgene flanking sequence.

FIG. 5C is a flow chart showing another embodiment of a method of identifying a transgene flanking sequence according to the flow chart of FIG. 5A.

FIG. 6 is an exemplary sequence according to an embodiment of the present disclosure.

FIG. 7 is an exemplary input screen of an identification system according to an embodiment of the present disclosure.

FIG. 8 is an exemplary output from the analysis system according to an embodiment of the present disclosure.

FIG. 9A is an exemplary screen showing the position of an expression vector, adapter, primer, and transgene flanking sequence.

FIG. 9B is an input sequence graphically identified in FIG. 9A.

FIG. 9C is a transgene expression vector 103 sequence graphically identified in FIG. 9A.

FIG. 9D is an adapter sequence graphically identified in FIG. 9A.

FIG. 9E is a primer sequence graphically identified in FIG. 9A.

FIG. 9F is the genomic sequence flanking the transgene identified from the input sequence of FIG. 9B.

FIG. 10 is an exemplary screen showing a transgene flanking sequence with a primer, but no right cloning vector.

FIG. 11 is an exemplary screen shot showing a transgene flanking sequence with an expression vector sequence, but no cloning vectors.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION OF THE DRAWINGS

The embodiments of the disclosure described herein are not intended to be exhaustive or to limit the disclosure to the precise forms disclosed. Rather, the embodiments selected for description have been chosen to enable one skilled in the art to practice the subject matter of the disclosure. Although the disclosure describes specific configurations of an analysis system, it should be understood that the concepts presented herein may be used in other various configurations consistent with this disclosure. Further, although the analysis of transgene flanking sequences are discussed, the teachings herein may be applied to the analysis of other sequences. The systems and methods described may be applicable to output from any molecular method for identifying and characterizing transgene flanking sequences, and the systems and methods provide an automated way of locating the transgene insertion site or sites within a genome. In an embodiment, the methods and systems also provide neighboring sequences and a local environment surrounding the insertion site, to determine if there are rearrangements in the local environment at or near the insertion site.

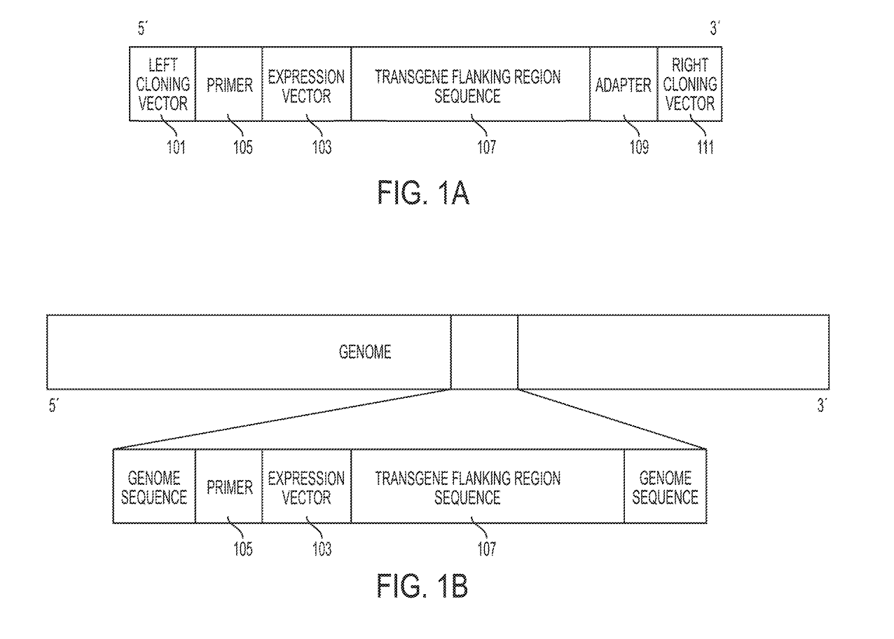

An ideal isolated insertion sequence, according to the embodiment shown with reference to FIG. 1A, includes a left cloning vector 101, a primer 105, transgene flanking region sequence 107 transgene expression vector sequence 103, an adapter 109, and a right cloning vector 111. The left cloning vector 101 and right cloning vector 111 are parts of a cloning vector, which is a first sequence of DNA that a second sequence of DNA may be inserted into. The insertion of the second sequence of DNA divides the cloning vector into a right (3′ portion) cloning vector 111 and a left (5′ portion) cloning vector 101. In an embodiment, the digestion of a cloning vector is completed by a restriction enzyme or via another method known in the art, thereby resulting in a cleaved DNA fragment. The digestion of the cloning vector at a single specific site generally yields a known left cloning vector 101 and right cloning vector 111 sequence. The insertion sequence inserted into a genome sequence is shown with respect to FIG. 1B. The expression vector 103 is a sequence that is used to introduce a gene into a target cell. A primer 105 is a short DNA sequence used to begin the process of DNA synthesis. The expression vector 103, is generally a sequence used for integration of a transgene into a genome. The transgene flanking region sequence 107 is the genomic sequence immediately upstream or downstream of the transgene insertion site; in the embodiment this sequence may either be known or unknown. An adapter 109 is a short oligonucleotide sequence which is ligated or annealed to the end of the transgene flanking sequence 107. In the embodiment, the sequence of the adapter 109 is known, and is used to mark the end of the sequence and can also be used to amplify or sequence the unknown transgene flanking sequence 107. The transgene flanking sequence 107 consists of a chromosomal flanking region of the genomic integration site flanking the integrated transgene. The transgene flanking sequence may contain deletions, inversions, or insertions which result from the integration of the transgene into a specific location of the chromosome. In an embodiment, the isolated sequence is ordered as a left cloning vector 101, a primer 105, an expression vector sequence 103, a transgene flanking region sequence 107, an adapter 109, and a right cloning vector 111, as illustrated in FIG. 1A, however, the order of the sequence is not limited to those illustrated in FIGS. 1A and 1B.

Shown in the FIG. 1B, primer 105, expression vector 103, transgene flanking region sequence 107, are inserted into a genome sequence, and appear within the genome sequence. The adapter sequence is incorporated later as part of a method used to isolate the transgene flanking sequence. The resulting transgene flanking sequence as depicted in FIG. 1A is then subsequently analyzed using data analysis methods shown below. In the ideal sequence, the sequences of the left cloning vector 101, the expression vector 103, the primer 105, the adapter 109, and the right cloning vector 111 are all known. In practice, one or more of the sections of the ideal sequence may be missing or may contain alterations.

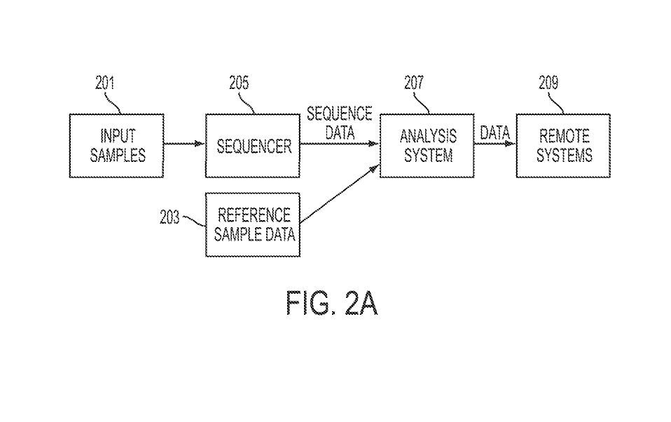

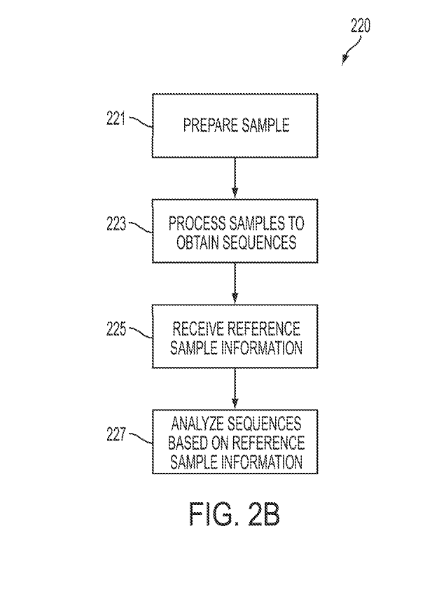

FIG. 2A shows the flow of data and samples from sample input to the analysis system 207. FIG. 2B shows a flow chart 220 showing a method of data analysis according to an embodiment of the present disclosure. In box 221, input samples 201 are prepared with, for example and without limitation, a ZFN-initiated transgene insertion protocol. In the protocol, one or more portions of known sequences, such as a primer 105 or adapter 109, are added to a target genome whose sequence is also known. The samples may also be prepared by other methods of transgene insertion. The transgene insertion process creates modified sequences, with insertions at one or more sites in the genome. An exemplary modified sequence is provided in FIG. 1B.

In box 223, one or more sequencers 205 generate sequence data from one or more input samples 201. The sequencers 205 determine the transgene flanking region sequence which is used to identify the location of the insertion in the genome, and confirm the specific sequence of the transgene insertion. The sample data, in the embodiment, is in the form of one or more text files including sequence data.

The input samples 201 are loaded into a sequencer 205 according to a protocol or operating instructions of the sequencer 205. For example, a Solexa ILLUMINA brand sequencing machine or a Roche 454 brand sequencing machine may be used. The sequencer 205 generates data related to the sequences 201. The data may include, but is not limited to, one or more text files, Standard Flowgram Format (“SFF”) or similar files, images files, or other data files containing information related to the sequences of the DNA strands in the input samples 201. In an embodiment, the sequence information also includes confidence data, so that each base in a sequence may have a confidence interval associated with it, or each sequence has a confidence interval associated with it. The confidence interval is a mathematical calculation calculated by the sequencer, and may include the strength of the read of the particular base by the sequencer 205. In one illustrative example, the confidence interval is an integer from one to nine. In the example, a confidence interval of one indicates that the sequencer 205 has relatively low confidence that the base reported was the base in the DNA strand. A confidence interval of nine indicates that the sequencer 205 has relatively high confidence that the base reported was the base in the DNA strand. In an embodiment, the sequencer 205 also reports other information in addition to the confidence interval. For example, the sequencer 205 may report when a base could not be read.

The data from the sequencer 205 is provided to the analysis system 207. In an embodiment, the data is provided by a network or a dedicated connection between the sequencer and the analysis system 207, or by a removable storage from the sequencer to the analysis system 207. In another embodiment, the sequencer prints the data to a screen or to a printer, and the data is input into the analysis system 207 from, for example and without limitation, a keyboard or a scanner. In one embodiment, the analysis system 207 is a part of the sequencer.

In box 225, the reference sample information 203 is transmitted to the analysis system 207. The reference sample information 203 may include, but is not limited to, the sequences of the left and right cloning vectors, which may be provided as a single sequence, the expression vector 103, the primer 105, and the adapter 109. The sequence information, in an embodiment, is transferred to the analysis system 207 via a network. In another embodiment, the reference sample information 203 is transmitted to the analysis system 207 with the sequence information from the sequencers 205.

In box 227, the analysis system 207 receives the sequence data from the one or more sequencers 205, and analyzes the sequence data, as described more fully below. The analysis system 207 also takes reference sample data 203 as an input. The reference sample data 203 may include, for example and without limitation, sequence information of the adapter 109, the primer 105, the left 101 and/or right cloning vectors 111, the expression vector 103, or the target genome sequence information. In an embodiment, the entire target genome sequence data is provided to the analysis system 207. In another embodiment, a subset of the entire target genome sequence is provided to the analysis system 207. In yet another embodiment, the analysis system 207 sends a request for all or a portion of the target genome sequence to another system. The matched sequence data and other data produced by the analysis system 207 undergoes additional processing. Additional processing may include, but is not limited to, visualization, quantification, aggregation with data from other samples or other trials, or comparisons to a target genome sequence. The additional processing, in an embodiment, is carried out by another system. In another embodiment, the analysis system 207 carries out all or a portion of the additional processing. Additional processing is described below.

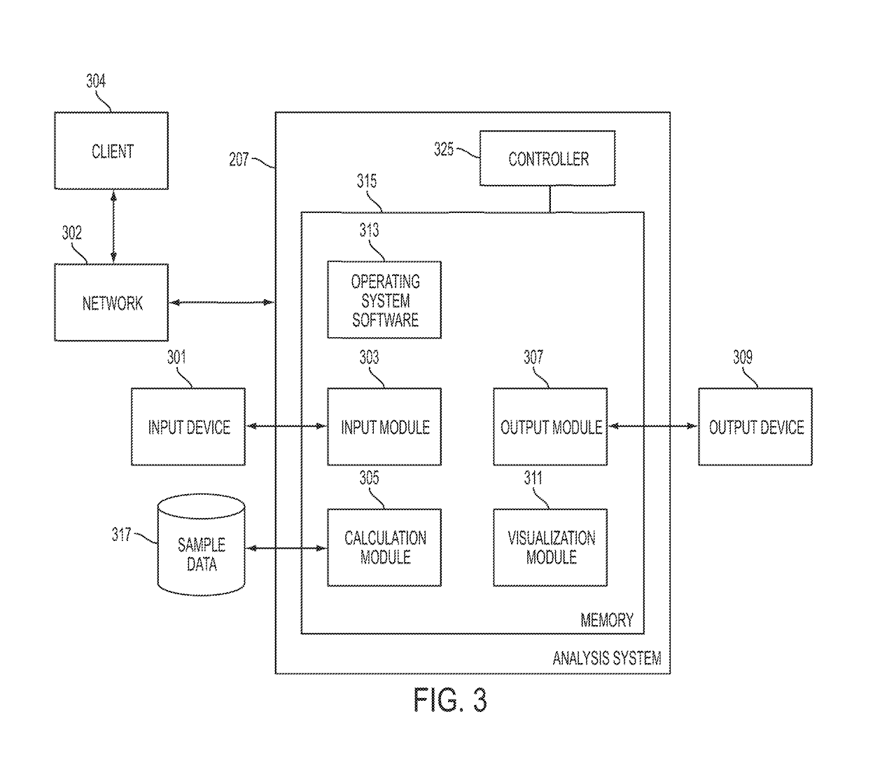

FIG. 3 shows a component view of the analysis system 207 according to an embodiment of the present disclosure. The analysis system 207 may include an input module 303, a calculation module 305, an output module 307, and a visualization module 311, which, in an embodiment, reside in memory 315 of the analysis system 207. The modules may be executed by a controller 325 of analysis system 207. In an embodiment, the controller 325 is one or more processors, and the controller 325 includes operating system software to control access to the controller 325 and the memory 315. The memory 315 includes computer readable media. Computer-readable media may be any available media that may be accessed by one or more processors of the analysis system 207 and includes both volatile and non-volatile media. Further, computer readable-media may be one or both of removable and non-removable media. By way of example, computer-readable media may include, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which may be used to store the desired information and which may be accessed by analysis system 207. The analysis system 207 may be a single system, or may be two or more systems in communication with each other. In one embodiment, the analysis system 207 includes one or more input devices, one or more output devices, one or more processors, and memory associated with the one or more processors. The memory associated with the one or more processors may include, but is not limited to, memory associated with the execution of the modules, and memory associated with the storage of data. In an embodiment, the analysis system 207 is associated with one or more networks, and communicates with one or more additional systems via the one or more networks. The modules may be implemented in hardware or software, or a combination of hardware and software. In an embodiment, the analysis system 207 also includes additional hardware and/or software to allow the analysis system 207 to access the input devices, the output devices, the processors, the memory, and the modules. The modules, or a combination of the modules, may be associated with a different processor and/or memory, for example on distinct systems, and the systems may be located separately from one another. In one embodiment, the modules are executed on the same system as one or more processes or services. The modules are operable to communicate with one another and to share information. Although the modules are described as separate and distinct from one another, the functions of two or more modules may instead be executed in the same process, or in the same system.

The input module 303 receives data from an input device 301. The input module 303 may also receive data over a network from another system. For example, and without limitation, the input module 303 receives one or more signals from a computer over one or more networks. The input module 303 receives data from the input device 301, and may rearrange or reprocess the data into a format recognizable by the calculation module 305, so that the data may be interpreted by the calculation module 305. The input device 301 may, in an embodiment, be a client 304, which a user interacts with to send signals to and receive signals from the analysis system 207. The client 304 may communicate with the analysis system 207 via one or more networks 302.

The network 302 may include one or more of: a local area network, a wide area network, a radio network such as a radio network using an IEEE 802.11× communications protocol, a cable network, a fiber network or other optical network, a token ring network, or any other kind of packet-switched network may be used. The network 302 may include the Internet, or may include any other type of public or private network. The use of the term “network” does not limit the network to a single style or type of network, or imply that one network is used. A combination of networks of any communications protocol or type may be used. For example, two or more packet-switched networks may be used, or a packet-switched network may be in communication with a radio network.

The input device 301 may communicate with the input module 303 via a dedicated connection or any other type of connection. For example, and without limitation, the input device 301 may be in communication with the input module 303 via a Universal Serial Bus (“USB”) connection, via a serial or parallel connection to the input module 303, or via an optical or radio link to the input module 303. The transmission may also occur via one or more physical objects. For example, the sequencer generates one or more files, and the sequencer or a user copies the one or more files to a removable storage device, such as a USB storage device or a hard drive, and a user may remove the removable storage device from the sequencer and attach it to the input module 303 of the analysis system 207. Any communications protocol may be used to communicate between the input device 301 and the input module 303. For example, and without limitation, a USB protocol or a Bluetooth protocol may be used.

In one embodiment, the input device 301 is a sequencer. The sequencer analyzes one or more samples and generates sequence data regarding the one or more samples. The sequencer may communicate the sequence data to the input module 303 over a wireless or wired connection.

In an embodiment, the data is in the form of one or more files, or the sequencer may print the data to a screen or a printer, and the data is input into the analysis system 207 by, for example and without limitation, a keyboard, mouse, or scanner. In an embodiment, the sequencer also includes additional data describing the samples.

The calculation module 305 receives inputs from the input module 303, and executes one or more processing sequences based on the inputs. For example, and without limitation, the calculation module 305 receives sequence information and reference sample information for the sequences. Sample data includes the sequence information, for example and without limitation, the primer 105, the left and/or right cloning vectors 111, the expression vector 103, and/or the target genome. The sample data may be provided to the analysis system 207 by the user, by the sequencer, by a third party system, by another system associated with the analysis system 207, by a combination of two or more of these inputs or other suitable sources. The sample data may be provided to the analysis system 207 as a text file in a standard format. For example, and without limitation, the text file may be formatted in the FASTA format. In another embodiment, the sample data information may be input into the analysis system 207 by typing or pasting information into one or more text entry fields. The information may be formatted in the FASTA format, or another standardized format. In another embodiment, other formats may be used. For example, the Genbank® format may be used, or another format. The analysis system 207 may receive the sample data in a particular format, and may reformat the data to be further analyzed by the analysis system 207.

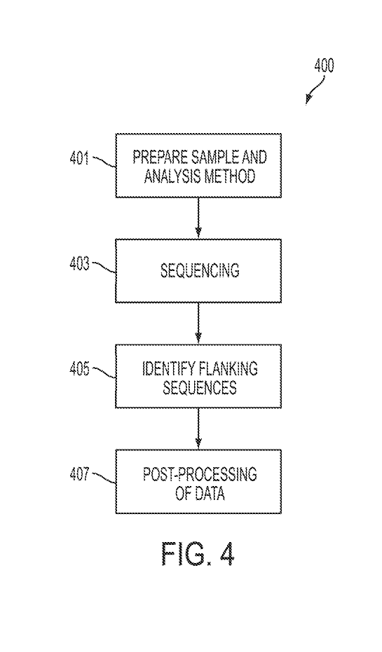

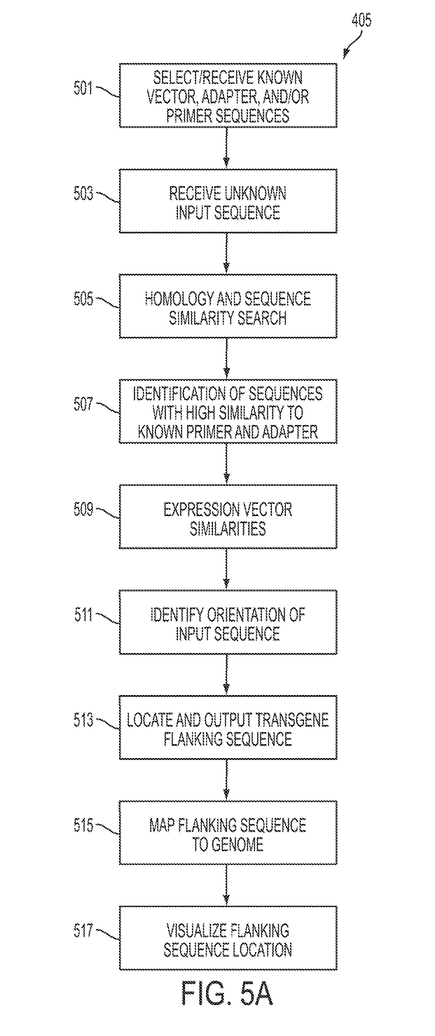

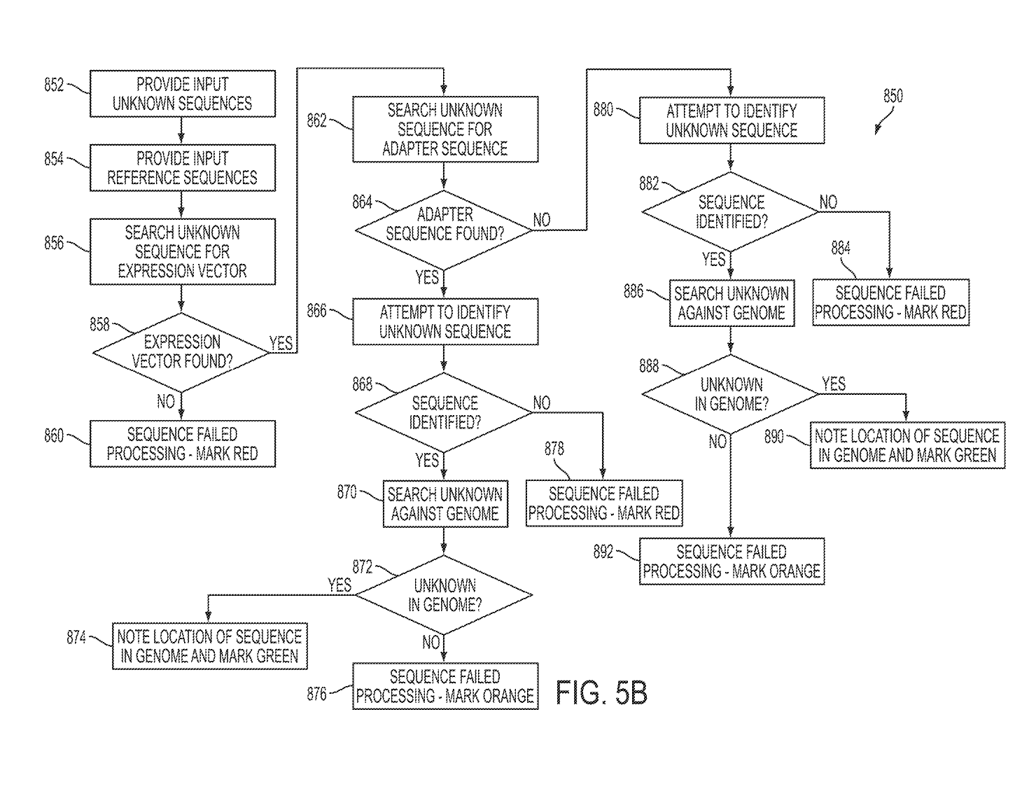

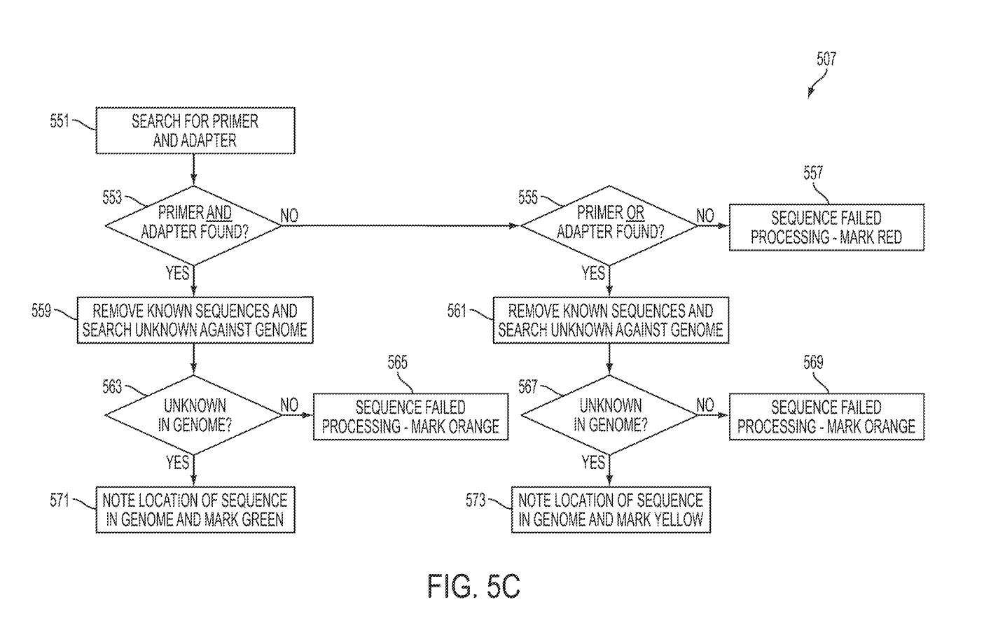

The calculation module 305 applies one or more algorithms to identify the vector and/or adapter 109 within the input sequence, identify the orientation of the input sequence, locate the transgene flanking sequence within the input sequence, based on the vector and/or adapter 109 within the input sequence, if possible, receives the genome information related to the input sequence, and attempts to map the flanking sequence to the genome. The algorithms generate additional quantitative and qualitative data related to the input sequences. Additionally, in an embodiment, the input sequences are annotated and analyzed and/or visualized. The algorithms and processes used to identify and annotate input sequences are described with respect to the flow charts shown in FIGS. 4, 5A, 5B, and 5C.

The calculation module 305 provides as an output, for example, data regarding the sequences and their position in a genome, and/or additional data to be used by a visualization module to visualize one or more of the sequences.

The visualization module 311 receives data as input regarding the input sequences and the annotations from the calculation module 305. The visualization module 311 allows a user to visualize and/or manipulate the sequences and/or annotations. In an embodiment, the visualization module 311 may use Gbrowse, or a modified version of Gbrowse. Other sequence visualization software programs may be used in additional embodiments. A user may have the ability to manipulate a visual representation of the target sequences, or the target sequences and the genome. The visualization module allows the user to view the location of the target sequences in the genome, or the location of other sequences of interest within the genome. The visualization step allows a user to locate the target sequence within the genome and the location or changes to other sequences of the genome. This visualization may be helpful for providing an analysis of the transgene flanking sequence.

The output module 307 receives an input, and transmits the input to an output device 309. In one embodiment, the output module 307 receives the input from the calculation module 305, the visualization device 311, or both the calculation module 305 and the visualization device 311. The received data may be in the form of alphanumeric data, and reformats the data to a format understandable to the output device 309, and transmits the data to the output device 309. The output module 307 and the output device 309 are in communication with one another. For example, and without limitation, the output module 307 and the output device 309 is in communication via a network, or is in communication via a dedicated connection, such as a cable or radio link. The output module 307 may also reformat the data received from the calculation module 305 into a format usable by the output device 309. For example, the output module 307 may create one or more files that may be read by the output device 309.

The output device 309 is, in an embodiment, a visualization system, another data analysis system 207, or a data storage system. The output module 307 communicates with the output device 309 by transmitting one or more electronic files to the output device 309. The transmission may occur over a dedicated link, for example a USB connection or a serial connection, or may occur over one or more network connections. The transmission may also occur via one or more physical objects. For example, the output module 307 may generate one or more files, and may copy the one or more files to a removable storage device, such as a USB storage device or a hard drive, and a user may remove the removable storage device from the analysis system 207 and attach it to the visualization system, another data analysis system 207, or the data storage system.

FIG. 4 shows a flow chart showing a method of data analysis according to an embodiment of the present disclosure. In box 401, the samples are prepared according to one or more preparation protocols, and unknown samples are created with transgene insertions.

In box 403, the unknown samples are sequenced. Sequencing may occur according to a protocol or operating instructions of the sequencer. For example, a Solexa ILLUMINA brand sequencing machine or a Roche 454 brand sequencing machine may be used. The sequencer generates data related to the sequences. The data may include, but is not limited to, one or more text files or other data files containing information related to the sequences of the DNA strands in the samples. In an embodiment, the sequence information also includes confidence data, so that each base in a sequence may have a confidence interval associated with it, or each sequence has a confidence interval associated with it. The confidence interval is a mathematical calculation calculated by the sequencer, and may include the strength of the read of the particular base by the sequencer. In one illustrative example, the confidence interval is an integer from one to nine. In the example, a confidence interval of one indicates that the sequencer has relatively low confidence that the base reported was the base in the DNA strand. A confidence interval of nine indicates that the sequencer has relatively high confidence that the base reported was the base in the DNA strand. In an embodiment, the sequencer also reports other information in addition to the confidence interval. For example, the sequencer may report when a base could not be read.

In box 405, the data from the sequencer is input into the analysis system 207, and the system locates and identifies the flanking sequences in each of the sequenced input sequences. Flanking sequences may not be present in each of the input sequences, or the system may not be able to identify the location of a flanking sequence in an input sequence. Sequences where the flanking sequence is located and identified are noted by the system, and sequences where the flanking sequence is not located, or is located but not identified, are also noted by the system. The system generates output data based on the sequence data and the analysis conducted by the system. Exemplary analysis of sequence data is also described below with reference to FIGS. 5A-5C.

In box 407, the system performs post-processing analysis on the sequence data and the flanking sequence location information as determined by the system. The sequence data, the target genome, and/or the flanking sequence location information may be visualized, qualitative measurements may be made with the data, and/or quantitative measurements may be made with the data.

FIG. 5A is a flow chart showing an exemplary method executed by analysis system 207 for flanking sequence identification. In box 501, the expression vector 103 that is used as a part of the protocol to generate the input sequences is input into the system. In some embodiments, one or more of the sequences for the right and left cloning vectors, the primer 105, and/or the adapter 109 are also provided. In a more particular embodiment, each of the sequences for the right and left cloning vectors, the primer 105, and the adapter 109 are also provided. The sequences for the cloning vectors, the expression vector 103, the primer 105, and the adapter 109 are typically known, so that they can be identified and located within the genome. The information for the known sequences is input into the system to allow for identification of the sequences when compared to the input sequences.

In box 503, the input sequences are received from the sequencers or from one or more files. The one or more files may be transmitted to the system via, for example, a network, or may be provided to the system in another way. If sequence information is received from the sequencers, it may be transmitted to the system via, for example, a network. In an embodiment, the sequence information is in an electronic form that can be transmitted to the system and read by the system. The sequence information may, in an embodiment, include verification data or other additional data to ensure that the sequence information has not been corrupted or altered during transmission. In another embodiment, the sequence information is stored in one or more databases, and the sequence information is transmitted from the one or more databases to the system via, for example, a network. Additionally, the genome information may be received from another database across a network. For example, the genome information may be stored in a publicly accessible database, or a privately accessible database, and the genome information may be requested by the system, and the entire genome or a requested portion of the genome may be transmitted to the system based at least in part on the request.

In box 505, the analysis system 207 searches the input sequence for similarities with the known sequences including expression vector 103. If provided in step 501, the analysis system 207 may further search similarities with the cloning vectors, primer 105, and/or adapter 109 sequences. If one or more of these sequences is not provided in step 501, the analysis system 207 treats the sequence as not found. The analysis system 207 may use different search parameters to search for different sequences. For example, in one embodiment, the analysis system 207 may use a more stringent set of search parameters to identify the primer 105 and adapter 109, as they are shorter sequences and less likely to have been modified. The analysis system 207 may use comparatively less stringent search parameters to search for the other sequences in the input sequence, as they are longer and/or more likely to have been altered during the integration of the transgene into the genome. In an embodiment, the analysis system 207 must find the exact sequence to identify the expression vector 103. In another embodiment, the analysis system 207 identifies the expression vector 103 if the sequence for the expression vector 103 is found to within a margin of error. For example, the margin of error may be five percent of the base pairs in the expression vector 103 sequence. In another embodiment, the margin of error is greater or smaller than five percent.

In an embodiment, the analysis system 207 uses the LASTZ alignment program and algorithms to search for sequence similarity between the input sequence and the known sequences consisting of the cloning vector, transgene expression vector 103, primer 105, and/or adapter 109 sequences. The LASTZ program is described in Harris, R. S. (2007) Improved pairwise alignment of genomic DNA. Ph.D. Thesis, The Pennsylvania State University, the disclosure of which is hereby incorporated by reference in its entirety. The LASTZ program performs two kinds of sequence similarity searches. The first kind of sequence similarity search is an “exact search” which is a specific parameter setting of the LASTZ program. An “exact search” requires 95% identity, no gaps in the sequence, and at least 15 perfect character matches within the sequence. A scoring matrix is used to determine a “score” for the sequence, with the matrix including 1 for a match with the target sequence and −10 for mismatch with the target sequence. This search is used to identify the primer 105 and the adapter 109 within the input sequence if provided, since the primer 105 and adapter 109 in the input sequence are expected to be exactly the same as the primer 105 and adapter 109 sample sequences, as the primer 105 and adapter 109 sequences are short and therefore unlikely to have been modified during the experiment. The second kind of sequence similarity search is a “loose search.” The “loose search” does not have the same stringent requirements as the “exact search.” This search uses the default parameters for LASTZ, and is deployed for finding the transgene expression vector 103 and cloning vector sequence similarities in the input sequence. A “loose search” is used for the transgene expression vector 103 and cloning vector sequences, as they are longer and therefore more likely to have been modified during the experiment.

Subsequences, within the input sequence, which share sequence similarity with a reference data sequence are labeled as a “type.” In the embodiment, there are four possible “types:” primer 105, adapter 109, transgene expression vector 103, and cloning vector. Where one or more of the primer 105, adapter 109, transgene expression vector 103, and cloning vectors is not provided in step 501, steps 503 and 505 are skipped for that type. For instance, highly similar sequences between the input sequence and any of the selected primer 105 sequences are labeled or associated as the “primer 105 type.” Likewise, if the user selects 15 transgene expression vector 103 sequences to be included in the analysis and each has 30 homologies to subsequences within the input sequence, all 450 sequences will be associated with the type “transgene expression vector 103.”

Shown in box 507, sequences that align with the highest levels of sequence similarity and alignment length to primer 105 sequences are classified as “primer 105 type.” Similarly, sequences that align with highest levels of sequence similarity and alignment length to adapter 109 sequences are classified as “adapter 109 type.” In the event that the alignment length and the alignment score are the same between an adapter 109 and a primer 105 in the input sequence, the sequence “type” is chosen arbitrarily from all of the tied sequences. These two sequences, “primer 105 type” and “adapter 109 type,” are identified first. They are identified first because the location of their motifs indicates what sequence was amplified and how it is oriented. If these two sequence types can be located, their position will identify the location of the transgene and cloning vector sequences.

Shown in box 509, once the search for the primer 105 and adapter 109 sequence similarity is completed, the analysis system 207 searches the input sequence for the transgene expression vector 103 which shares the most sequence similarity. This search is conducted in one of two different ways, depending on whether or not a sequence similar to the primer 105 was identified. If a primer 105 sequence was identified in the input sequence, the best match containing the primer 105 is identified. In one embodiment, if the primer 105 was not provided in step 501 or identified in step 507, or none of the transgene expression vector 103 sequences contain a sequence which shares similarity with the “primer 105 type,” the best overall match is considered and the transgene expression vector 103 with the highest sequence similarity is chosen. “Best overall match” in this context means choosing the match with the highest levels of sequence similarity and alignment lengths.

Once the transgene expression vector 103 is located and identified, location and identification of the cloning vector sequence via sequence similarity alignments to known cloning vectors is attempted. Once a putative transgene expression vector 103 sequence is identified, the sequences upstream and downstream of this sequence are further characterized. The upstream cloning vector sequence is queried to identify cloning vectors which share sequence similarity at the start and end coordinates. The previously annotated sequences (transgene expression vector 103, primer 105, and adapter 109) are not queried. As such, the analysis system 207 searches all possible cloning vectors for sequence similarity with the region upstream from the previously identified feature. Then the analysis system 207 searches identified cloning vector sequence information for sequence similarity with the region downstream from the previously identified feature cloning vector in a similar manner. The vectors are identified by choosing the match with the highest levels of sequence similarity and alignment lengths.

Shown in box 511, the orientation of the input sequence is identified, if possible. In order to facilitate comparisons and further calculations, the analysis system 207 attempts to order input sequences in a left hand to right hand orientation; that is, with the 5′ end of the sequence on the left side and the 3′ end of the sequence on the right side. In some instances, the sequencer may have sequenced the antisense strand of the DNA, in which case the sequence has to be reverse complemented. Once the sequences of each “type” (i.e. primer 105, adapter 109, cloning vector, and transgene expression vector 103) within the input sequence have been identified, the system uses this information to identify and/or orient the input sequence. Orientation is determined by the location of the primer 105 and adapter 109 sequences. A forward orientation, wherein the primer 105 is located before the adapter 109 is preferred because of ease of visualization.

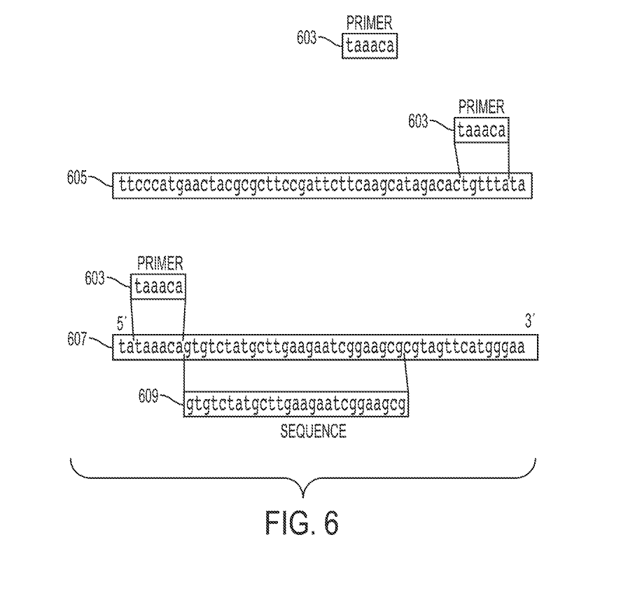

An example of an input sequence from the antisense strand is shown in FIG. 6. In FIG. 6, the sequence of the primer 105 is known to the analysis system 207 as “TAAACA.” In an embodiment, if input sequence 605 is read by the analysis system 207, the analysis system 207 may initially not find either the primer 603 sequence in the input sequence 605. The analysis system 207 reverse complements the input sequence 605 to resolve a reverse complemented sequence 607, and compares the primer 105 to the reverse complemented sequence 607. The analysis system 207 system, in the example, finds an exact match of the primer 603 to subsequences within the reverse complemented sequence 607. The analysis system 207 isolates the sequence 609 from the known primer 603, and proceeds with analysis of the reverse complemented sequence 607. In an embodiment, the analysis system 207 instead compares reverse complemented sequences for the known primer 603 to the sequence 605, and, having identified the reverse complemented primer sequence 603, may reverse complement the entire sequence to yield a reverse complemented sequence 607, and may proceed with processing with the reverse complemented sequence 607.

Shown in box 513, the transgene flanking sequence is located within the input sequence or the reverse complemented sequence, if the sequence was reverse complemented in the previous step. Exemplary location methods are described more fully with respect to FIGS. 5B and 5C.

Shown in box 515, the transgene flanking sequence, if found in the previous step, is located within the genome. The transgene flanking sequence is located in an integration site within the genome and is upstream or downstream of the transgene insertion site and contiguous with the expression vector sequence. The integration site is determined using a matching algorithm. For example the Basic Local Alignment Search Tool (BLAST) algorithm may be used. The BLAST algorithm is described in Altschul S. F, et al., “Basic local alignment search tool.” J Mol Biol. 1990 Oct. 5; 215(3):403-10, the disclosure of which is hereby incorporated by reference in its entirety. The inputs for the BLAST search are the transgene flanking sequence and the genome. The BLAST search locates, if possible, the site or sites of integration of the transgene flanking sequence into the genome. The output of the BLAST search is a list of possible integration sites and a score for the fit. All masking and low complexity filtering is disabled for this homology search, to identify as many integration sites as possible. After the search is performed, the output is parsed to find the top hit, which has the highest score for the fit. Once a top hit is identified, this region is considered to be the putative integration site of the transgene.

For a given transgene integration site, linked endogenous upstream and downstream genes which are annotated in the genome are identified using a computer script. The input file of genome annotations is parsed, and the genes are indexed by chromosome and sorted by start coordinate. When an integration site is determined, the system identifies the appropriate list of gene coordinates and performs a binary search to identify the correct insertion point for the integration site. The sorted list of coordinates for the transgene integration site will appear. From this point, the list is searched forward until a sequence greater than 10 kilobase pairs from the integration site is located. Then the list is searched backward until a sequence greater than 10 kilobase (kb) pairs from the integration site is located. In this way, genes in the genome upstream and downstream of the integration site are annotated for further analysis. The distance parameter can be varied, for example and without limitation, to >10 kb or <10 kb of the integration site. Other ranges from the integration site may also be used.

If a transgene integration site is found for an input sequence, it is important to determine if the sequence between the transgene and the chromosomal flanking sequence contains a rearrangement, insertion, or deletion. To give the user confidence that the integration site is not altered i.e. the sequence of the integration site has not been rearranged or modified resulting in deletions or insertions during the transgene integration process, the analysis system 207 calculates the amount of overlap that exists between the chromosomal flanking sequence and any other sequence “types” used in any of the previously mentioned processes. This measure is calculated as the ratio of the number of bases in the input sequence similarity that are unique and not overlapped by any other sequence similarity (unique_bases) and the total number of bases in the input sequence similarity (total_bases).

$$\frac{unique\_bases}{total\_bases}$$

This ratio gives a quantitative value to the integration site.

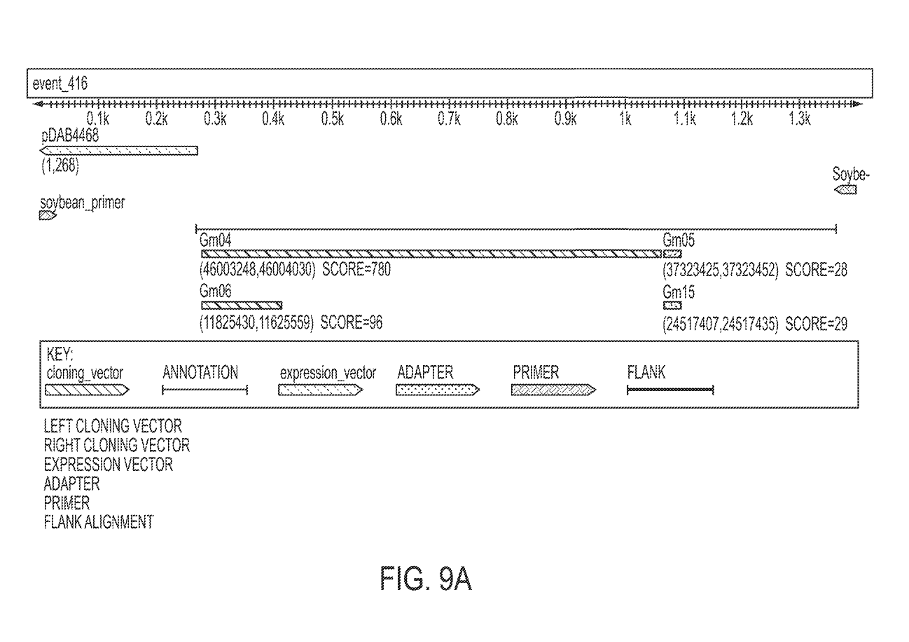

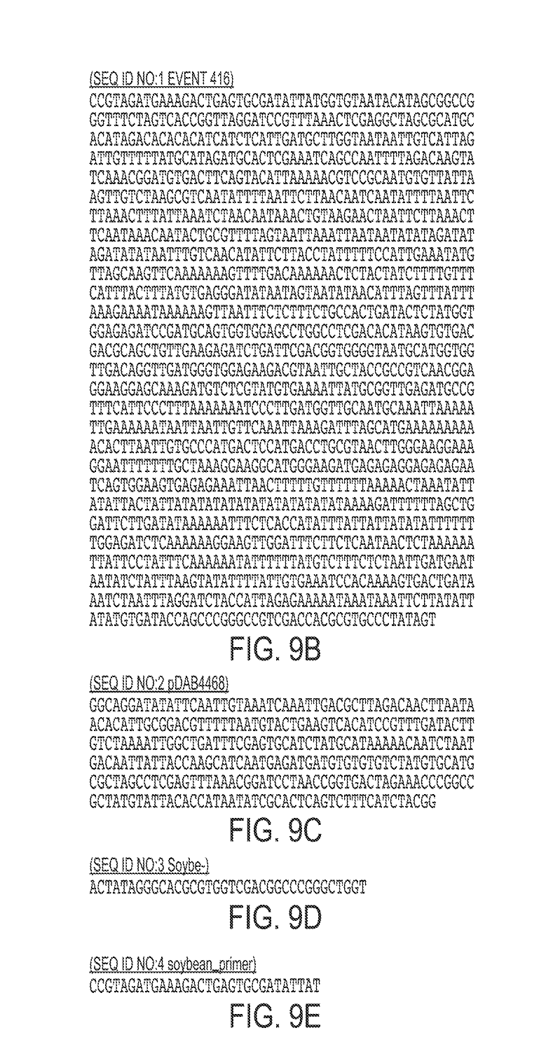

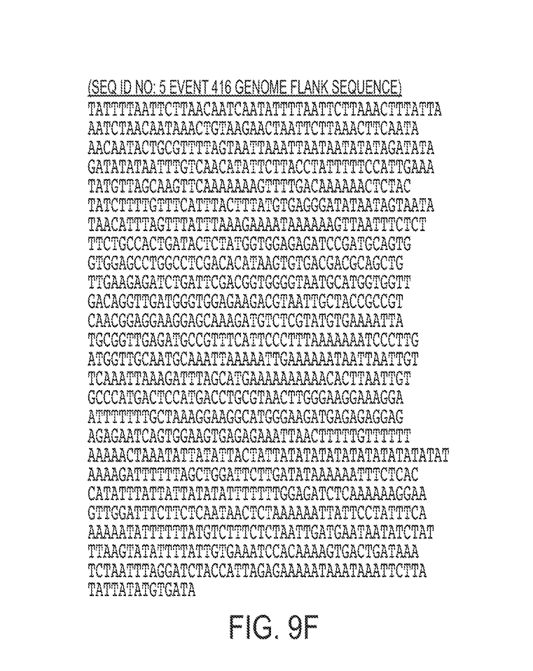

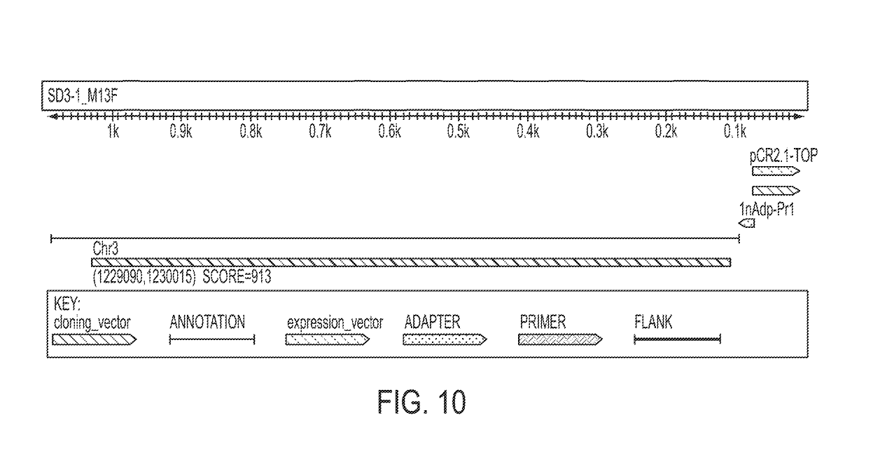

The annotated data from the previous boxes in FIG. 5A may, in an embodiment, be presented for visual inspection in box 517. Examples of visualization are shown in FIGS. 9A and 10. Additionally, the input sequence, the transgene flanking sequence, and/or additional information regarding the cloning vectors, the expression vector 103, the primer 105, the adapter 109, or the input sequence, is presented for visualization. Data regarding the transgene flanking sequence, the cloning vectors, the expression vector 103, the primer 105, the adapter 109, or the input sequence is also saved to one or more electronic files.

FIG. 5B is a flow chart showing a generalized method of marking a transgene flanking sequence 850. In box 852, the expression vector 103 that is used as a part of the protocol to generate the input sequences is input into the system. In some embodiments, one or more of the sequences for the right and left cloning vectors, the primer 105, the transgene expression vector sequence 103, and the adapter 109 are also provided. In a more particular embodiment, each of the sequences for the right and left cloning vectors, the primer 105, the transgene expression vector sequence 103, and the adapter 109 are also provided. The sequences for the cloning vectors, the expression vector 103, the primer 105, and the adapter 109 are typically known, so that they can be identified and located within the input unknown sequence. The information for the known sequences is input into the system to allow for identification of the sequences when compared to the input sequences.

In box 854, the input sequences are received from the sequencers or from one or more files. The one or more files may be transmitted to the system via, for example, a network, or may be provided to the system in another way. If sequence information is received from the sequencers, it may be transmitted to the system via, for example, a network. In an embodiment, the sequence information is in an electronic form that can be transmitted to the system and read by the system. The sequence information may, in an embodiment, include verification data or other additional data to ensure that the sequence information has not been corrupted or altered during transmission. In another embodiment, the sequence information is stored in one or more databases, and the sequence information is transmitted from the one or more databases to the system via, for example, a network. Additionally, the genome information may be received from another database across a network. For example, the genome information may be stored in a publicly accessible database, or a privately accessible database, and the genome information may be requested by the system, and the entire genome or a requested portion of the genome may be transmitted to the system based at least in part on the request.

In box 856, the analysis system 207 searches the input sequence for similarities with the known sequences including a first reference sequence, illustratively expression vector 103. If the expression vector 103 is not found in box 858, the method proceeds to box 860. The lack of expression vector 103 may indicate an error in the creation or the processing of the input sequence. In box 860, the input sequence is marked as failing and is not matched against the genome. In an embodiment, the sequence is marked as red when the sequences are visualized.

If the expression vector 103 is found in box 858, the method 850 proceeds to box 862. In an embodiment, the analysis system 207 must find the exact sequence of expression vector 103 to proceed to box 862. In another embodiment, the analysis system 207 may proceed to box 862 if the sequences for the expression vector 103 is found to within a margin of error. For example, the margin of error may be five percent of the base pairs in the expression vector 103 sequence. In another embodiment, the margin of error is greater or smaller than five percent.

In box 862, the analysis system 207 searches the input sequence for similarities with the known sequences including a second reference sequence, illustratively adapter sequence 109. If the adapter sequence 109 is found, in box 864 the method proceeds to box 866. If the adapter sequence 109 is not found, in box 864 the method proceeds to box 880. In an embodiment, the analysis system 207 must find the exact sequence of adapter sequence 109 to proceed to box 866.

In another embodiment, the analysis system 207 may proceed to box 866 if the sequence for the adapter sequence 109 is found to within a margin of error. For example, the margin of error may be five percent of the base pairs in the adapter sequence 109. In another embodiment, the margin of error is greater or smaller than five percent.

If adapter sequence is found, the method 550 proceeds to box 866. In box 866, analysis system 207 attempts to identify the unknown sequence input in box 854. In one embodiment, the known adapter is removed from the unknown sequence prior to further processing. In another embodiment, the known adapter is not removed from the unknown sequence prior to further processing. If the unknown sequence is identified, the method proceeds to box 870. If the unknown sequence is not identified, the method proceeds to box 878. The failure to identify the unknown sequence may indicate an error in the creation or the processing of the sequence. In box 878, the input sequence is marked as failing processing. In an embodiment, the sequence is marked as red when the sequences are visualized.

In box 870, the input sequence is searched against the genome. In one embodiment, the BLAST search algorithm is used to attempt to match the reduced input sequence to the genome. In box 872, if the input sequence is matched against the genome, the method proceeds to box 874. If the reduced input sequence is not matched to any position in the genome, then the method proceeds to box 876.

In box 874, the input sequence matches against a portion of the genome. The analysis system 207 notes the location of the input sequence in the genome, and also notes the regions of interest in neighboring regions of the location. In an embodiment, the analysis system 207 notes regions of interest within 200 kilobase pairs of the location. In other embodiments, the analysis system 207 notes regions of interest within a larger or smaller amount of base pairs. In an embodiment, the user is able to specify the size of the neighboring region that the analysis system 207 notes around the location. In an embodiment, the sequence is marked as green when the sequences are visualized.

In box 876, the input sequence is marked as failing to match against the genome. The reduced input sequence may have been damaged during sequencing, or may have been sequenced incorrectly. In an embodiment, the sequence is marked as orange when the sequences are visualized.

As stated earlier, if, in box 864 the adapter sequence 109 is not found, the method 850 proceeds to box 880. In box 880, analysis system 207 attempts to identify the unknown sequence input in box 854. If the unknown sequence is identified in box 882, the method proceeds to box 886. If the unknown sequence is not identified, the method proceeds to box 884. The failure to identify the unknown sequence may indicate an error in the creation or the processing of the sequence. In box 884, the input sequence is marked as failing processing. In an embodiment, the sequence is marked as red when the sequences are visualized.

In box 886, the input sequence is searched against the genome. In one embodiment, the BLAST search algorithm is used to attempt to match the reduced input sequence to the genome. In box 888, if the input sequence is matched against the genome, the method proceeds to box 890. If the reduced input sequence is not matched to any position in the genome, then the method proceeds to box 892.

In box 890, the input sequence matches against a portion of the genome. The analysis system 207 notes the location of the input sequence in the genome, and also notes the regions of interest in neighboring regions of the location. In an embodiment, the analysis system 207 notes regions of interest within 200 kilobase pairs of the location. In other embodiments, the analysis system 207 notes regions of interest within a larger or smaller amount of base pairs. In an embodiment, the user is able to specify the size of the neighboring region that the analysis system 207 notes around the location. In an embodiment, the sequence is marked as green when the sequences are visualized.

In box 892, the input sequence is marked as failing to match against the genome. The reduced input sequence may have been damaged during sequencing, or may have been sequenced incorrectly. In an embodiment, the sequence is marked as orange when the sequences are visualized.

FIG. 5C is a flow chart showing another method of marking a transgene flanking sequence 507 according to the flow chart of FIG. 5A in which the known sequence for the primer 105, adapter 109, or both are provided in step 501. In box 551, the analysis system 207 searches for the sequences identified as the primer 105 and the adapter 109 in the input sequence.

In box 553, the analysis system 207 searches for the adapter 109 and the primer 105 within the input sequence. If both the adapter 109 and the primer 105 sequences were provided in step 501 and are found within the input sequence, the method proceeds to box 559. If either the adapter 109 or the primer 105 sequences are not found within the input sequence, or if either the adapter 109 or the primer 105 sequences are not provided in step 501, the method proceeds to box 555. In an embodiment, the analysis system 207 must find the exact sequence of both the adapter 109 and the primer 105 to proceed to box 559. In another embodiment, the analysis system 207 may proceed to box 559 if the sequences for the adapter 109 and the primer 105 are found to within a margin of error. For example, the margin of error may be five percent of the base pairs in the adapter 109 or the primer 105 sequences. In another embodiment, the margin of error is greater or smaller than five percent. In another embodiment, the margin of error for the primer 105 and the margin of error for the adapter 109 are different.

In box 559, the known sequences for the adapter 109 and the primer 105 are removed from the input sequence, so that the input sequence is reduced to the sequence between the adapter 109 and the primer 105. The reduced input sequence is searched against the genome. In one embodiment, the BLAST search algorithm is used to attempt to match the reduced input sequence to the genome.

In box 563, if the reduced input sequence is matched against the genome, the method proceeds to box 571. If the reduced input sequence is not matched to any position in the genome, then the method proceeds to box 565, and the input sequence is marked as failing to match against the genome. The reduced input sequence may have been damaged during sequencing, or may have been sequenced incorrectly, or the adapter 109 and the primer 105 may have abutted one another in the sequence, leaving no reduced input sequence. In an embodiment, the sequence is marked as orange when the sequences are visualized.

In box 571, the reduced input sequence matches against a portion of the genome. The analysis system 207 notes the location of the input sequence in the genome, and also notes the regions of interest in neighboring regions of the location. In an embodiment, the analysis system 207 notes regions of interest within 200 kilobase pairs of the location. In other embodiments, the analysis system 207 notes regions of interest within a larger or smaller amount of base pairs. In an embodiment, the user is able to specify the size of the neighboring region that the analysis system 207 notes around the location. In an embodiment, the sequence is marked as green when the sequences are visualized.

If both of the adapter 109 and the primer 105 are not found within the input sequence, or the adapter 109 and the primer 105 sequences are not found within the tolerances set by the analysis system 207 or the user, the method proceeds from box 553 to box 555. In box 555, the analysis system 207 determines if either of the adapter 109 or the primer 105 sequences are found in the input sequence. If either of the adapter 109 or the primer 105 sequences are found in the input sequence, the method proceeds to box 561. If both of the adapter 109 and the primer 105 sequences are not found in the input sequence, the method proceeds to box 557.

In box 557, neither the adapter 109 nor the primer 105 were found within the input sequence. The lack of primer 105 and adapter 109 may indicate an error in the creation or the processing of the input sequence. The input sequence is marked as failing, and is not matched against the genome. In an embodiment, the sequence is marked as red when the sequences are visualized.

In box 561, either the adapter 109 or the primer 105 sequences are found within the input sequence. In an embodiment, the adapter 109 or the primer 105 sequences are found within the input sequence to within a margin of error. The missing adapter 109 or primer 105 sequences indicates that the input sequence of the input sequence extends to either the 5′ or the 3′ end of the input sequence, and so the input sequence may not have captured the entire sequence of the input sequence. The known adapter 109 or the known primer 105, whichever is present in the input sequence, is removed from the input sequence so that the input sequence is reduced to the sequence between the adapter 109 and the primer 105. The reduced input sequence is searched against the genome, shown in box 567. In one embodiment, a BLAST search algorithm is used to attempt to match the reduced input sequence to the genome.

In box 567, if the reduced input sequence is matched against the genome, the method proceeds to box 573. If the reduced input sequence is not matched to any position in the genome, then the method proceeds to box 569, and the input sequence is marked as failing to match against the genome. The reduced input sequence may have been damaged during sequencing, or may have been sequenced incorrectly, or the adapter 109 and the primer 105 may have abutted one another in the sequence, leaving no reduced input sequence. In an embodiment, the sequence is marked as orange when the sequences are visualized.

In box 573, the reduced input sequence matches against a portion of the genome. The analysis system 207 notes the location of the input sequence in the genome, and also notes the regions of interest in neighboring regions of the location. In an embodiment, the analysis system 207 notes regions of interest within 200 kilobase pairs of the location. In other embodiments, the analysis system 207 notes regions of interest within a larger or smaller amount of base pairs. In an embodiment, the user is able to specify the size of the neighboring region that the analysis system 207 notes around the location. Regions of interest may include sequences encoding genes or other genomic information. Regions of interest may be received from a third party system, for example the system from which the analysis system 207 received the genome sequence information. In an embodiment, the sequence is marked as yellow when the sequences are visualized.

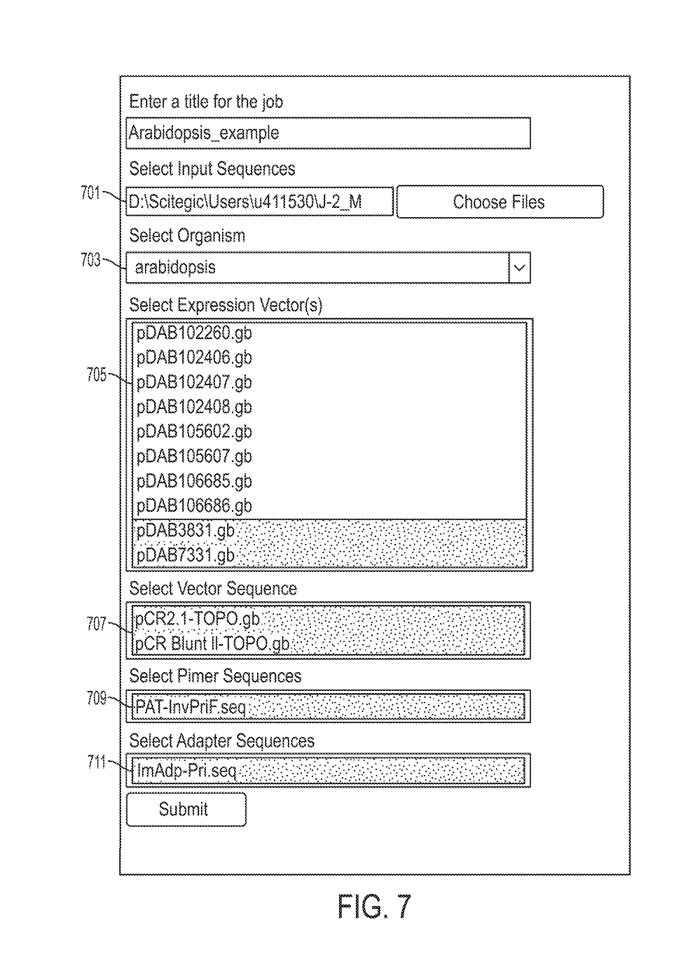

FIG. 7 shows a sample input screen for the analysis system 207. The user may select a series of input sequences in box 701. The input sequences may be in a standard form for providing sequence information, or may be a form that the analysis system 207 can parse and identify. The user may also select an organism's genome to map the input sequences against. The genome may be provided by the analysis system 207, so that the user identifies one or more genomes available to the analysis system 207, or the user may provide a path to an electronic file that contains sequence information for the organism's genome. The genome may be complete or partial. The user, in box 705, selects one or more expression vectors 103 used in the experiment and which should be present in the input sequences. The user, in boxes 707, 709, and 711, selects the vector sequences, the primer 105 sequences, and the adapter 109 sequences, respectively, that were used in the experiment and which should be present in the input sequences. The user then presses the “Submit” button to begin the data importation process and the analysis.

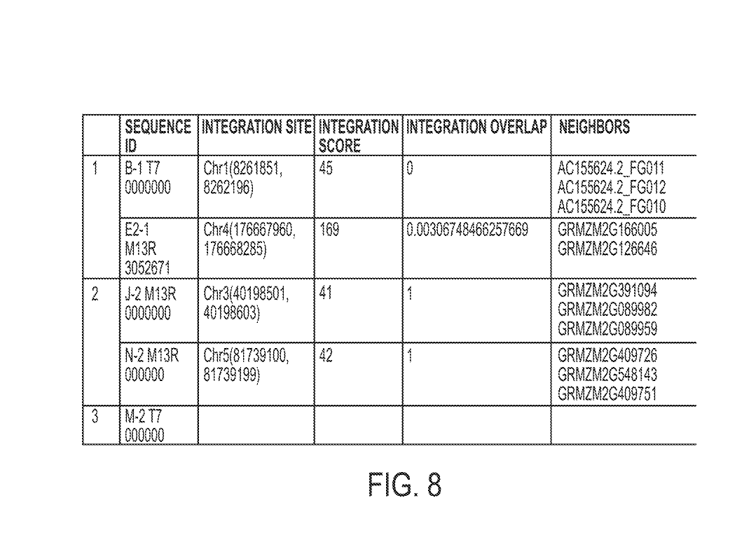

FIG. 8 shows an exemplary output of the analysis system 207 according to an embodiment of the present disclosure. In the embodiment, the rows of the table labeled ‘1’ indicate input sequences in which a chromosomal flanking sequence was identified correctly by the analysis system 207. These rows may be color coded, for example color coded green, for differentiation from the other rows. The rows of the table labeled ‘2’ indicate input sequences in which a chromosomal flanking sequence was identified, but the analysis contains anomalies because all known sequences searched could not be identified so that, for example, the adapter 109 could not be located within the input sequence. These rows may be coded as a different color than the rows of the table labeled ‘1.’ The rows of the table labeled ‘3’ indicate input sequences in which a chromosomal flanking sequence could not be identified. These rows are color coded as red. The Neighbors column indicate genes from a genomic sequence which proximal to the integration site.

FIG. 9A shows a summary display of the analysis system 207 which provides a graphical display of the integration site analysis for a particular input sequence from exemplary Soybean Event 416. At the top of the image, the coordinates of the input sequence are displayed. The remaining sequences that are shown within this summary display are annotated relative to these coordinates. The input reference sequence, in the exemplary screen, are oriented so that the primer 105 and transgene expression vector 103 appear on the left hand side of the screen, and the genomic flanking sequence and adapter 109 appear on the right hand side of the screen. The graphic display shows the input sequence for Event 416 (SEQ ID NO:1) (shown as FIG. 9B) that has been annotated to identify the transgene expression vector 103 (“pDAB4468”; SEQ ID NO:2) (shown as FIG. 9C), adapter 109 (“Soybe-”; SEQ ID NO:3) (shown as FIG. 9D) and primer 105 (“soybean_primer”; SEQ ID NO:4) (shown as FIG. 9E) sequences within it. The identified chromosomal flanking sequence is annotated as a solid line (SEQ ID NO:5) (shown as FIG. 9F). The analysis system 207, in the example, has aligned the chromosomal flanking sequence with the Glycine max genome. The chromosomal flanking sequence aligns to region 46003248, 46004030 of chromosome 4 with a sequence similarity score of 780; region 11825430, 11825559 of chromosome 6 with a sequence similarity score of 96; region 24517407, 24517435 of chromosome 15 with a sequence similarity score of 29; and region 37323425, 37323452 of chromosome 5 with a sequence similarity score of 28. The input sequence, the transgene expression vector 103, the adapter 109, and the primer 105 are graphically represented in the figure.

FIG. 10 shows the application of the analysis system 207 for use in Arabidopsis thaliana. Illustrated is the summary display of the analysis system 207 which provides an intuitive graphical display of the integration site analysis for an input sequence. At the top of the image, the coordinates of the input sequence are displayed. The remaining sequences that are shown within this summary display are annotated relative to these coordinates. The graphic display shows the input sequence for the event that has been annotated to identify the cloning vector (“pCR2.1-TOP”) and adapter 109 (“1mAdp-Pri”). The identified chromosomal flanking sequence is annotated as a solid line. The analysis system 207 has aligned the chromosomal flanking sequence with the Arabidopsis genome sequence. The chromosomal flanking sequence is aligned to a specific region of the Arabidopsis genomic sequence identifier 1229090, 1230015 and a sequence similarity score of 913 is reported. FIG. 10 shows a transgene flanking sequence with a primer 105, but no right cloning vector 111.

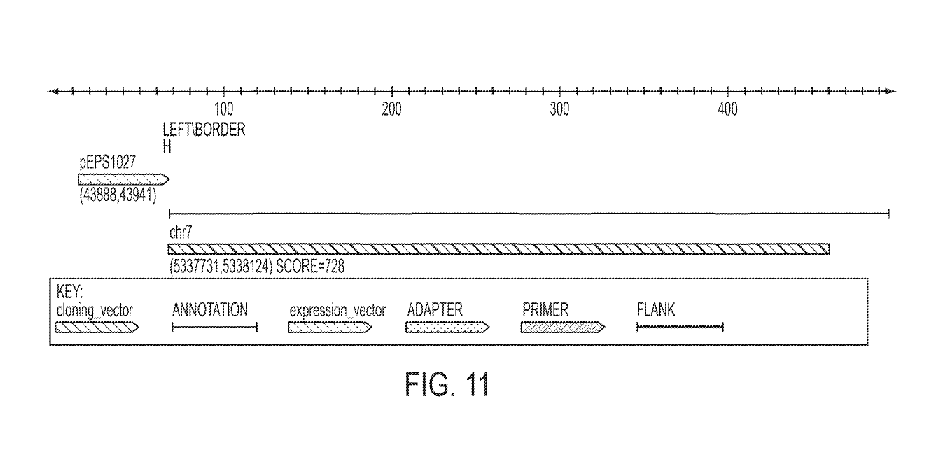

FIG. 11 shows the application of the analysis system 207 for use in maize. Illustrated is the summary display of the analysis system 207 which provides an intuitive graphical display of the integration site analysis for an input sequence. At the top of the image, the coordinates of the input sequence are displayed. The remaining sequences that are shown within this summary display are annotated relative to these coordinates. The graphic display shows the input sequence for the event that has been annotated to identify the expression vector 103 (“pEPS1027”). The identified chromosomal flanking sequence is annotated as a solid line. The analysis system 207 has aligned the chromosomal flanking sequence with the maize genome sequence. The chromosomal flanking sequence is aligned to a specific region of the Zea genomic sequence identifier 5337731, 5338124 and a sequence similarity score of 728 is reported. FIG. 11 shows a transgene flanking sequence with an expression vector 103, but no right or left cloning vector s 101, 111.

While this disclosure has been described as having exemplary designs, the present disclosure can be further modified within the spirit and scope of this disclosure. This application is therefore intended to cover any variations, uses or adaptations of the disclosure using its general principles. Further, this application is intended to cover such departures from the present disclosure as come within known or customary practice in the art to which this disclosure pertains and which fall within the limits of the appended claims.

What is claimed is:

1. A method for analysis, comprising:
electronically receiving sequence data;
electronically receiving one or more reference data sequences related to at least an expression vector;
associating the sequence data with at least one of the reference data sequences to identify a transgene flanking sequence;
searching a genome for one or more insertion sites of the transgene flanking sequence; and
annotating the genome and the one or more insertion sites within the genome when one or more insertion sites are found in said searching step.

2. The method of claim 1, wherein the reference data is further related to at least one of a left cloning vector, a primer, an adapter, and a right cloning vector.

3. The method of claim 1, wherein the reference data is further related to a left cloning vector, a primer, an adapter, and a right cloning vector.

4. The method of claim 1, further comprising:
searching the sequence data for a first reference data sequence; and
searching the sequence data for a second reference data sequence when said first reference data sequence is located.

5. The method of claim 4, wherein the first reference data sequence is selected from the group consisting of: an expression vector, an adapter, a primer, and a cloning vector.

6. The method of claim 5, wherein the second reference data sequence is selected from the group consisting of: an expression vector, an adapter, a primer, and a cloning vector, the second reference data sequence being selected independently of the first reference data sequence.

7. The method of claim 4, wherein the first reference data sequence is an expression vector and the second reference data sequence is an adapter.

8. The method of claim 4, wherein the first and second reference data sequences are independently selected from the group consisting of: a primer and an adapter.

9. The method of claim 1, further comprising visualizing the transgene flanking sequence and the reference data.

10. The method of claim 1, further comprising visualizing the one or more insertion sites within the genome.

11. The method of claim 1, further comprising characterizing sequence information of the genome upstream and downstream of the insertion site.

12. The method of claim 11, wherein sequence information of the genome 10 kilobase pairs upstream and 10 kilobase pairs downstream of the insertion site are characterized.

13. The method of claim 1, further comprising:
aligning the sequence data with one or more of the reference data sequences; and
conducting a qualitative analysis of the aligned sequences.

14. The method of claim 1, further comprising:
aligning the sequence data with one or more of the reference data sequences; and
conducting a quantitative analysis of the aligned sequences.

15. The method of claim 1, wherein the genome is at least a portion of a plant genome.

16. The method of claim 1, wherein associating the sequence data with at least one of the reference data sequences includes using an algorithm to match at least one of the reference data sequences against the sequence data.

17. The method of claim 16, wherein the algorithm is a LASTZ algorithm.

18. The method of claim 1, wherein searching a genome for one or more insertion sites of the transgene flanking sequence includes using an algorithm to locate sequences upstream and downstream of the at least one insertion site with the genome.

19. The method of claim 18, wherein the algorithm is a BLAST algorithm.

20. A system for analysis, comprising:
a module for receiving sequence data related to a sequence;
a module for receiving one or more reference sequences related to at least an expression vector; and
a calculation module operable to:
associate the sequence data with at least one of the reference data sequences to identify a transgene flanking sequence;
search a genome for one or more insertion sites of the transgene flanking sequence; and
annotate the genome and the one or more insertion sites within the genome. when the one or more insertion site is found.

21. The system of claim 20, wherein the reference sequences are further related to at least one of a left cloning vector, a primer, an adapter, and a right cloning vector.

22. The system of claim 20, wherein the reference sequences are further related to a left cloning vector, a primer, an adapter, and a right cloning vector.

23. The system of claim 20, wherein said computation module is further operable to:
search the sequence data for a first reference data sequence; and
search the sequence data for a second reference data sequence when said first reference data sequence is located.

24. The system of claim 23, wherein the first reference data sequence is selected from the group consisting of: an expression vector, an adapter, a primer, and a cloning vector.

25. The system of claim 24, wherein the second reference data sequence is selected from the group consisting of: an expression vector, an adapter, a primer, and a cloning vector, the second reference data sequence being selected independently of the first reference data sequence.

26. The system of claim 23, wherein the first reference data sequence is an expression vector and the second reference data sequence is an adapter.

27. The system of claim 23, wherein the first and second reference data sequences are independently selected from the group consisting of: a primer and an adapter.

28. The system of claim 20, further comprising a module for visualizing the transgene flanking sequence and at least one of the left cloning vector, the expression vector, the primer, the adapter, and the right cloning vector.

29. The system of claim 20, further comprising a module for visualizing the one or more insertion sites within the genome.

30. The system of claim 20, wherein said computation module is further operable to characterize sequence information of the genome upstream and downstream of the insertion site.

31. The system of claim 30, wherein said computation module is operable to characterize sequence information of the genome 10 kilobase pairs upstream and 10 kilobase pairs downstream of the insertion site.

32. The system of claim 20, wherein said computation module is operable to:
align the sequence data with one or more of the reference data sequences; and
conduct a qualitative analysis of the aligned sequences.

33. The system of claim 20, wherein said computation module is operable to:
align the sequence data with one or more of the reference data sequences; and
conduct a quantitative analysis of the aligned sequences.

34. The system of claim 20, wherein the genome is at least a portion of a plant genome.

35. The system of claim 20, wherein associating the sequence data with at least one of the reference data sequences includes using an algorithm to match at least one of the reference data sequences against the sequence data.

36. The system of claim 35, wherein the algorithm is a LASTZ algorithm.

37. The system of claim 20, wherein searching a genome for one or more insertion sites of the transgene flanking sequence includes using an algorithm to locate sequences upstream and downstream of the at least one insertion site with the genome.

38. The system of claim 37, wherein the algorithm is a BLAST algorithm.


SEQUENCE LISTING (8 sequences)

SEQ ID NO: 1 - DNA, 1395 bp, Artificial Sequence
  event 416 input sequence
ccgtagatgaaagactgagtgcgatattatggtgtaatacatagcggccgggtttctagtcaccggttaggatccgtttaaactcgaggctagcgcatgcacatagacacacacatcatctcattgatgcttggtaataattgtcattagattgtttttatgcatagatgcactcgaaatcagccaattttagacaagtatcaaacggatgtgacttcagtacattaaaaacgtccgcaatgtgttattaagttgtctaagcgtcaatattttaattcttaacaatcaatattttaattcttaaactttattaaatctaacaataaactgtaagaactaattcttaaacttcaataaacaatactgcgttttagtaattaaattaataatatatagatatagatatataatttgtcaacatattcttacctatttttccattgaaatatgttagcaagttcaaaaaaagttttgacaaaaaactctactatcttttgtttcatttactttatgtgagggatataatagtaatataacatttagtttatttaaagaaaataaaaaagttaatttctctttctgccactgatactctatggtggagagatccgatgcagtggtggagcctggcctcgacacataagtgtgacgacgcagctgttgaagagatctgattcgacggtggggtaatgcatggtggttgacaggttgatgggtggagaagacgtaattgctaccgccgtcaacggaggaaggagcaaagatgtctcgtatgtgaaaattatgcggttgagatgccgtttcattccctttaaaaaaatcccttgatggttgcaatgcaaattaaaaattgaaaaaataattaattgttcaaattaaagatttagcatgaaaaaaaaaacacttaattgtgcccatgactccatgacctgcgtaacttgggaaggaaaggaatttttttgctaaaggaaggcatgggaagatgagagaggagagagaatcagtggaagtgagagaaattaactttttgttttttaaaaactaaatattatattactattatatatatatatatatatatataaaagattttttagctggattcttgatataaaaaatttctcaccatatttattattatatatttttttggagatctcaaaaaaggaagttggatttcttctcaataactctaaaaaattattcctatttcaaaaaatattttttatgtctttctctaattgatgaataatatctatttaagtatattttattgtgaaatccacaaaagtgactgataaatctaatttaggatctaccattagagaaaaataaataaattcttatattatatgtgataccagcccgggccgtcgaccacgcgtgccctatagt

SEQ ID NO: 2 - DNA, 295 bp, Artificial Sequence
  transgene expression vector 103 sequence
ggcaggatatattcaattgtaaatcaaattgacgcttagacaacttaataacacattgcggacgtttttaatgtactgaagtcacatccgtttgatacttgtctaaaattggctgatttcgagtgcatctatgcataaaaacaatctaatgacaattattaccaagcatcaatgagatgatgtgtgtgtctatgtgcatgcgctagcctcgagtttaaacggatcctaaccggtgactagaaacccggccgctatgtattacaccataatatcgcactcagtctttcatctacgg

SEQ ID NO: 3 - DNA, 36 bp, Artificial Sequence
  adapter 109 sequence
actatagggcacgcgtggtcgacggcccgggctggt

SEQ ID NO: 4 - DNA, 30 bp, Artificial Sequence
  primer 105
ccgtagatgaaagactgagtgcgatattat

SEQ ID NO: 5 - DNA, 1093 bp, Artificial Sequence
  event 416 genome flank sequence
tattttaattcttaacaatcaatattttaattcttaaactttattaaatctaacaataaactgtaagaactaattcttaaacttcaataaacaatactgcgttttagtaattaaattaataatatatagatatagatatataatttgtcaacatattcttacctatttttccattgaaatatgttagcaagttcaaaaaaagttttgacaaaaaactctactatcttttgtttcatttactttatgtgagggatataatagtaatataacatttagtttatttaaagaaaataaaaaagttaatttctctttctgccactgatactctatggtggagagatccgatgcagtggtggagcctggcctcgacacataagtgtgacgacgcagctgttgaagagatctgattcgacggtggggtaatgcatggtggttgacaggttgatgggtggagaagacgtaattgctaccgccgtcaacggaggaaggagcaaagatgtctcgtatgtgaaaattatgcggttgagatgccgtttcattccctttaaaaaaatcccttgatggttgcaatgcaaattaaaaattgaaaaaataattaattgttcaaattaaagatttagcatgaaaaaaaaaacacttaattgtgcccatgactccatgacctgcgtaacttgggaaggaaaggaatttttttgctaaaggaaggcatgggaagatgagagaggagagagaatcagtggaagtgagagaaattaactttttgttttttaaaaactaaatattatattactattatatatatatatatatatatataaaagattttttagctggattcttgatataaaaaatttctcaccatatttattattatatatttttttggagatctcaaaaaaggaagttggatttcttctcaataactctaaaaaattattcctatttcaaaaaatattttttatgtctttctctaattgatgaataatatctatttaagtatattttattgtgaaatccacaaaagtgactgataaatctaatttaggatctaccattagagaaaaataaataaattcttatattatatgtgata

SEQ ID NO: 6 - DNA, 50 bp, Artificial Sequence
  input sequence 605
ttcccatgaactacgcgcttccgattcttcaagcatagacactgtttata

SEQ ID NO: 7 - DNA, 50 bp, Artificial Sequence
  reverse complemented sequence 607
tataaacagtgtctatgcttgaagaatcggaagcgcgtagttcatgggaa

SEQ ID NO: 8 - DNA, 27 bp, Artificial Sequence
  sequence 609
gtgtctatgcttgaagaatcggaagcg